(19) United States
(12) Patent Application Publication
(10) Pub. No.: US 2025/0190961 A1
(43) Pub. Date: Jun. 12, 2025

(54) SYSTEM FOR MANAGING PAYMENT ROUTING

(71) Applicant: Wells Fargo Bank, N.A., San Francisco, CA (US)

(72) Inventors: Violeta Lopez Franco, Walnut Creek, CA (US); Michael Rene Lopez, Suisun City, CA (US); Ajita Panda, Pleasant Hill, CA (US); Daniel A. Porter, Concord, CA (US); Peter Rozovski, Concord, CA (US)

(21) Appl. No.: 18/535,737

(22) Filed: Dec. 11, 2023

(51) Int. Cl. G06Q 20/10; G06Q 20/02

(52) U.S. Cl. CPC G06Q 20/102; G06Q 20/027

(57) ABSTRACT

An electronic online system is configured to access a set of scheduled payments; determine a set of payees from the set of scheduled payments, the set of scheduled payments to be made using a non-electronic payment mode; access a set of billers; calculate a set of redirection billers based on a match of payees from the set of payees with billers from the set of billers, wherein billers in the set of redirection billers support electronic payment modes; and schedule electronic payments for the set of redirection billers using the set of electronic payment processors.

### BACKGROUND

Many financial institutions, such as banks, allow customers to access and manage their accounts via the internet and via applications running on internet-enabled devices (e.g., smartphones, tablets, etc.). Through the applications, customers can often view account balances, transfer funds between accounts, and deposit checks. Customers can pay bills such as cable and utility bills via the financial institution applications. The customers can associate authorized payees, such as the cable company or the utility company, with their account. Associating an authorized payee with a customer account often requires that the customer manually input payee information, such as company name, address, and company contact information. Then, the customers can authorize the bank to either transfer customer funds electronically to the payee or to send a physical payment, such as a check, to the payee to satisfy a bill from the payee.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a diagram illustrating data and control flow, according to an embodiment;

FIG. 3 is a user interface of a biller report, according to an embodiment;

FIG. 4 is a user interface of a payee report, according to an embodiment;

FIG. 5 is a user interface of a redirection analysis report, according to an embodiment;

FIG. 6 is a Matched Detail screen for a specific biller, according to an embodiment;

FIG. 7 is an example user interface to create and edit tasks, according to an embodiment;

FIG. 8 is a flowchart illustrating a method for rerouting electronic payments, according to an embodiment; and

FIG. 9 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a system for managing payment routing. With the advent of the internet and other large area networks, many financial transactions are conducted online. While there are many benefits to online transactions, these benefits do come with some cost. In the online payment technology space, there is a need to improve how payments are managed. Managing payments in an efficient manner reduce overall costs to banks and other financial institutions that process such payments. Reduction in economic costs is a high priority for many financial institutions. The economic costs may stem from various sources including cost of maintaining and operating computers, networking, and other equipment, cost of service fees for transactions, cost of personnel to operate the systems, and cost of auxiliary services related to online payments.

The present systems and methods described herein provide an approach to support online payments using a least-cost routing mechanism. The least-cost routing is used to minimize costs of processing online payments. Every day, financial institution customers create millions of new online payments. A financial institution may use multiple payment processors (both internal and external to the financial institution) to process payments. These payment processors cost money to process payments. The rates for payment processing are different for different payment processors and payment types (electronic or paper, what type of electronic, internal or external). Some payments can only be processed by one payment processor. However, a majority of payments can be processed by more than one payment processor. When considering which payment processor to use for which online payments, several factors have to be considered. This is a multi-criterial problem that has to consider an aggregate of processed payments for a payment processor over an extended period of time, such as months or years. For instance, to determine an optimal (e.g., least cost) payment routing between payment processors for a single transaction is a fairly simple problem. Such a solution is based on fixed rates (costs) of processing for each processor and the solution does not depend on payment processing history (e.g., how previous transactions were processed and their volume). However, when using multiple payment processors, each processor may have separate contract obligations. The contract obligations may include monthly minimal volumes of payments (counts) or annual minimal volumes of payments (counts) to use the processor or to obtain different rate tiers. The minimal volume requirements add criteria, resulting in a difficult optimization problem.

The embodiments described herein address the technical and internet-centric problem of handing online payments in an efficient manner to reduce costs—in both terms of financial costs and computer processing or operational costs. One mechanism to improve efficiency is the use of intelligent payment routing. The systems and methods here support intelligent payment routing to optimize computer performance and reduce costs. These functions and others are described in more detail below.

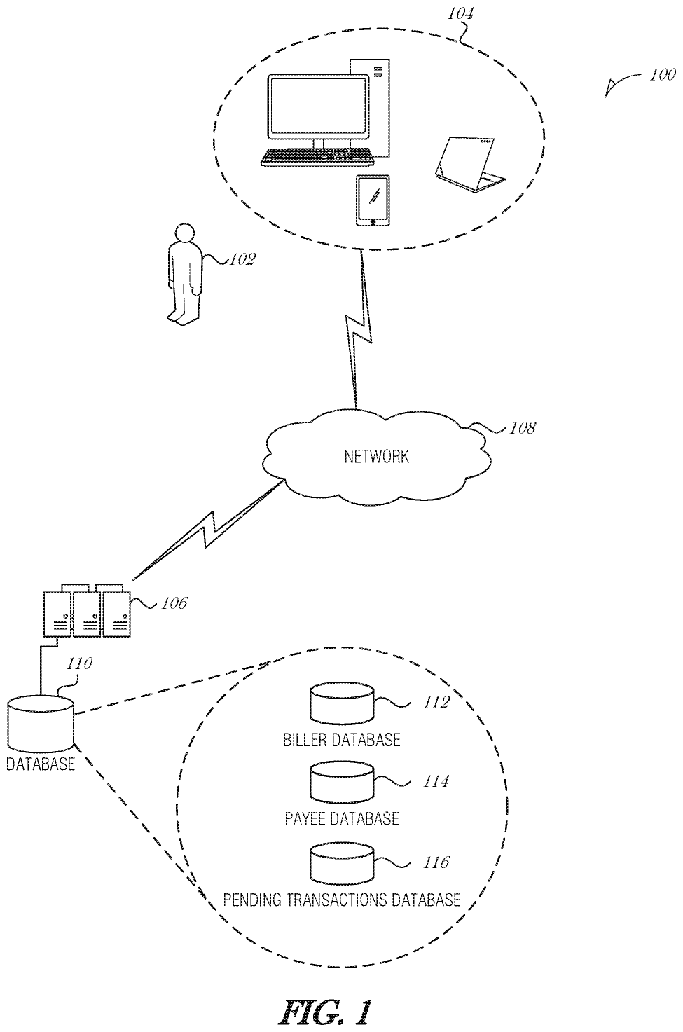

FIG. 1 is a diagram illustrating an operating environment 100, according to an embodiment. A user 102 may use a user device 104 to access a financial institution computing system 106. The financial institution computing system 106 may be operated by or incorporated with a financial institution's computing system. The user device 104 may be of any type of form factor including, but not limited to a desktop computer, a mobile device, a laptop computer, a smartphone, a tablet device, a personal digital assistant, or the like. The user 102 may be a person who fulfils a role, such as a system administrator, a business executive, a group manager, business unit administrator, financial advisor, financial analyst, business analyst, accounting clerk, or the like. Each role may have different permissions to execute functions or operations in the financial institution computing system 106. For instance, an administrator may be allowed to create a new database tasks, delete an existing database task, or revise a database task. A person with a non-elevated privilege (e.g., a regular user) may only have permissions to submit queries to the financial institution computing system 106 or execute existing available tasks, which operate on data in the financial institution computing system 106.

Database tasks may be a combination of one or more stored procedures, scripts, processes, queries, reports, microservices, or the like, which operate to retrieve data from the database 110, transform the data, and store transformed data in the database 110. Database tasks may be integrated into a database management system (DBMS) or may be implemented as separate from the DMBS. Database tasks may be implemented in standalone executable applications that access a database 110.

Alternatively, the user 102 may be a customer of the financial institution computing system 106. For instance, the user 102 may be a banking customer of a bank that operates the financial institution computing system 106. The user 102 may interact with the financial institution computing system 106 through user interfaces provided by the bank, such as an online banking experience, through a mobile app, or by interactive voice response (IVR). The user 102 may perform a number of different financial transactions, such as to transfer funds between accounts, deposit or withdraw money, check balances, or schedule online payments.

The financial institution computing system 106 may include various web servers, database servers, proxy devices, firewalls, storage devices, and network devices. The financial institution computing system 106 may provide a web-based interface accessible via a uniform resource locator (URL). The financial institution computing system 106 may provide various levels of security, such as requiring an account with a username and password, a secure channel (e.g., HTTPS), two-factor authentication, and the like.

To connect to the financial institution computing system 106, the user 102 may execute an application (“app”) to connect via a network 108. The app may be an internet browser application, a database query client application, a database console application, a custom user interface with a database interconnection to the financial institution computing system 106, or the like. In various examples, the servers and components in the operating environment 100 may communicate via one or more networks such as network 108. The network 108 may include one or more of local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 108 may include a single local area network (LAN) or wide-area network (WAN), or combinations of LANs or WANs, such as the Internet.

Data used in the financial institution computing system 106 may be organized and stored in a variety of manners. For convenience, the organized collection of data is described herein as a database 110. The specific storage layout and model used in the database 110 may take a number of forms. The database 110 may utilize multiple models. The database 110 may be, but is not limited to, a relational database (e.g., SQL), non-relational database (NoSQL), a flat file database, object model, document details model, or a file system hierarchy. The database 110 may be implemented using MongoDB using a JavaScript Object Notation (JSON) data format. The database 110 may store data on one or more storage devices (e.g., a hard disk, random access memory (RAM), etc.). The database 110 may include a cache database, such as Redis, to cache some or all of the database contents. The storage devices may be in standalone arrays, part of one or more servers, and may be located in one or more geographic areas.

A database management system (DBMS) may be used to access the data stored within the database 110. The DBMS may offer options to search the database 110 using a query and then return data in the database 110 that meets the criteria in the query. The DBMS may provide an interface to create, edit, or manage database tasks. The DBMS may be implemented, at least in part, with MongoDB Atlas. The DBMS may operate on one or more of the components of the financial institution computing system 106.

As used herein, a biller is defined as a tuple of at least an organization and a remittance addresses. An organization is any company, business, person, or the like that provides goods or services to a customer and then invoices the customer for those goods or services. Billers may be creditors, such as a credit card company, which offers a line of credit to a customer and invoices the customer monthly for charges against the line of credit. For instance, a credit card company “CREDIT ABC” may provide a credit card affiliated with the VISA payment card processing network. The credit card company may have several regional remittance locations to serve its national customer base. For instance, CREDIT ABC may have a west coast location in San Francisco, California, a mid-west location in Chicago, Illinois, and an east coast location in Atlanta, Georgia. In the database 110, there are three biller identifications, one for each combination of CREDIT ABC and the respective west, mid-west, and east coast locations. Thus, for CREDIT ABC, there are at least three biller entries in the database 110, each of which is a combination of organization and remittance address (e.g., there may be more than one remittance address in use in Chicago).

As used herein, a payee is defined as a tuple of at least an organization, a remittance address, and a customer account number. Each payee is unique to a customer. In general, a payee contains the information of the biller plus the customer's account number.

To store biller and payee information, the database 110 may include a biller database 112 and a payee database 114. The biller database 112 may contain profiles for a plurality of billers, including, for example, each biller's full name, aliases, previous names, phone numbers, remittance addresses, and the like. Multiple biller profiles for a given billing organization may exist in the biller database 112. For instance, there may be separate biller profiles for the same billing organization, where each biller profile is for a different remittance address of the billing organization. In some arrangements, customers (e.g., user 102) can send a request to the financial institution computing system 106 to add a specific biller to the biller database 112 by providing information sufficient to complete a biller profile.

The biller database 112 can be stored in the financial institution computing system 106 on any of several digital storage mediums such as disc-based or flash-based hard drives, local servers, offsite cloud-based servers, or a combination thereof. Although the biller database 112 is represented as a single unit in FIG. 1, the biller database 112 can be divided and stored in several storage mediums of varying types and in different, even remote, locations.

The payee database 114 may contain profiles of a plurality of payees, including, for example, each payee's full name, aliases, customer account number, and the like. Multiple payee profiles for a given biller may exist in the payee database 114. For instance, there may be separate payee profiles for the same biller, where each payee profile is for a different customer account of the biller. In some arrangements, customers (e.g., user 102) can send a request to the financial institution computing system 106 to add a specific payee to the payee database 114 by providing information sufficient to complete a payee profile. This is useful for private companies or individual payees, such as a personal payee (e.g., an individual person, a married couple, a babysitter, etc.) or a small business (e.g., a lawn mowing service, etc.).

The payee database 114 can be stored in the financial institution computing system 106 on any of several digital storage mediums such as disc-based or flash-based hard drives, local servers, offsite cloud-based servers, or a combination thereof. Although the payee database 114 is represented as a single unit in FIG. 1, the payee database 114 can be divided and stored in several storage mediums of varying types and in different, even remote, locations.

The database 110 includes pending transactions including pending payment transactions to payees. The pending transactions may be stored in the payee database 114 or in a separate database (e.g., pending transaction database 116) that references the payee database 114. When a customer accesses the financial institution computing system 106 to create a new scheduled payment for a payee, the pending payment transaction is stored in the database 110. The customer may schedule the payment to be paid non-electronically (e.g., by paper check, bank draft, cashier's check, money order, or the like). These types of payments cost the financial institution more than if the payment were to be sent electronically. Thus, there is a need to determine which pending payment transactions can be re-routed to electronic payments.

In operation, a user 102 may log into the financial institution computing system 106 to access and execute one or more of three database tasks: a “Biller Import” task, a “Payee Import” task, and a “Redirection Analysis” task. In general, the Biller Import task searches for all pending payments for each specific biller (i.e., unique combinations of payee organization name and remittance address), the Payee Import task searches for all pending payments for each payee (i.e., unique combinations of payee organization name, remittance address, and customer account number), and the Redirection Analysis task finds matches of those billers in the results of the Biller Import task that accept electronic payments, and the payees from the Payee Import task that match billers that accept electronic payments, and provides details of the matches (where the matches are referred to as redirection billers). The matched pending payments found by the Redirection Analysis task may be redirected from using non-electronic (e.g., paper) payments to electronic payments. Matches may be performed using a “scrub and match” (SAM) process, which transforms the profiles from both the biller result list and the payee result list to tokens, and then compares the tokens to determine whether there is a match. It is noted that an exact match is not necessary and that the match may be based on a partial match. Various types of acceptable partial matches are defined in SAM process.

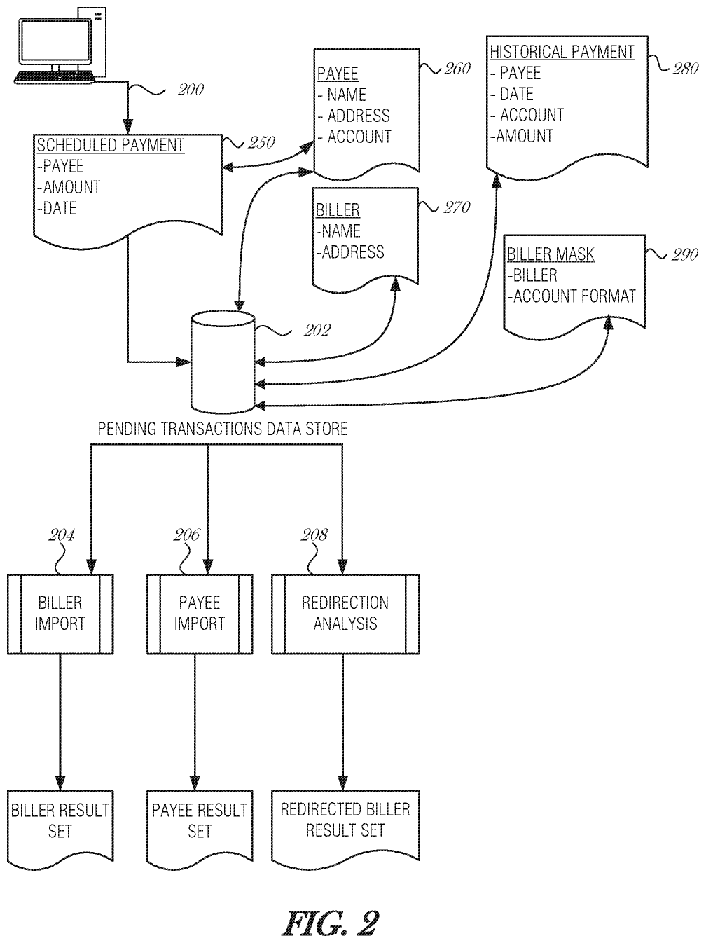

FIG. 2 is a diagram illustrating data and control flow, according to an embodiment. A user creates a scheduled payment to a payee (operation 200). The payee may be one of several payees available to the user for selection. As described above, the payee may be configured by the user based on the user's information of the payee.

The scheduled payment data structure 250 includes at least a reference to a payee data structure 260 (e.g., using a foreign key), a payment date, a payment amount, and optionally other information, such as a memo or note describing the payment. The payee data structure 260 includes at least a payee name, a payee address, and a customer account with the payee.

The biller data structure 270 includes at least a biller name and a remittance address. The scheduled payment data structure 250, payee data structure 260, or biller data structure 270 may include additional information depending on the design of the underlying database, and additional fields to capture other data about the corresponding scheduled payment, payee, or biller.

An historical payment data structure 280 includes data about previous payments made to a payee. Information stored in the historical payment data structure may include a payee identifier or name, an amount for the transaction, a date or time, a success indicator, a transaction identifier, an account number or reference, a customer (e.g., user) number or identifier, or the like.

A biller mask data structure 290 includes data indicating how an account number or other reference number for a biller is formatted. For instance, a VISA® credit card account may be in the form of a sixteen digit number with four groups of four numbers (e.g., NNNN-NNNN-NNNN-NNNN) with either dashes or spaces as separators. As another example, an AMERICAN EXPRESS® credit card account may be in the form of a fifteen digit number with groups of four, six, and five numbers (e.g., NNNNN-NNNNNN-NNNNN) with either dashes or spaces as separators. Other billers may use combinations of numbers or letters in various groups or formats. The biller mask data structure 290 stores the mask of an account reference corresponding to a biller.

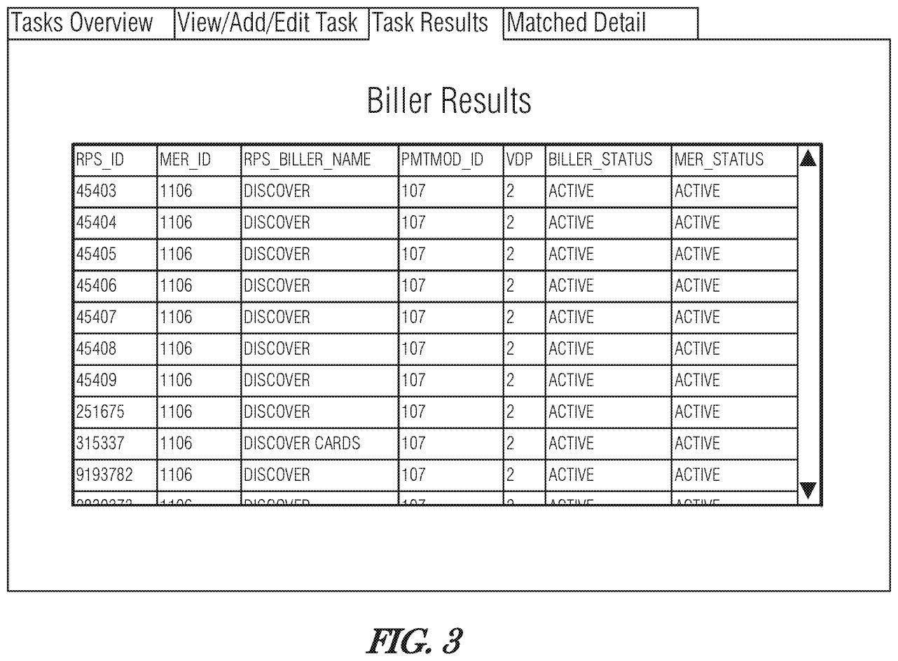

The scheduled payments are saved in a pending transactions data store 202 (e.g., pending transactions database 116), which may be one or more tables in one or more databases or other database structured as described herein. Based on the pending transactions data store 202, the “Biller Import” task 204 is able to identify one or more billers for payments that are due in the pending transactions data store 202. The Biller Import task 204 returns the billers that are included in the pending transactions data store 202. The Biller Import task 204 may also perform other operations. For instance, the Biller Import task 204 may act on processed payments (e.g., payments processed in the last month or last year) to find billers where it makes sense to redirect to electronic payments. The set of billers may be stored as a result set for use in other processes. FIG. 3 is a user interface of a biller report, according to an embodiment.

Turning to FIG. 3, the Biller Results screen provides a number of columns including, but not limited to RPS_ID, MER_ID, RPS_BILLER_NAME, PMTMOD_ID, VDP, BILLER_STATUS, and MER_STATUS. RPS_ID is a unique identifier of a biller, which is a merchant at a specific remittance address. MER_ID is a unique identifier of a merchant. For a given merchant, for example, “Big Bank,” there may be several merchant accounts for remittance, for example “Big Bank VISA,” “Big Bank MASTERCARD,” “Big Bank Home Mortgage,” etc. Each merchant account is associated with a distinct RPS_ID. The PMTMOD_ID is an identifier of the payment processor. The VDP is the time of the payment processing in the number of days. The BILLER_STATUS and MER_STATUS are the state of the biller and merchant in the system and may be set as “ACTIVE” or “INACTIVE.”

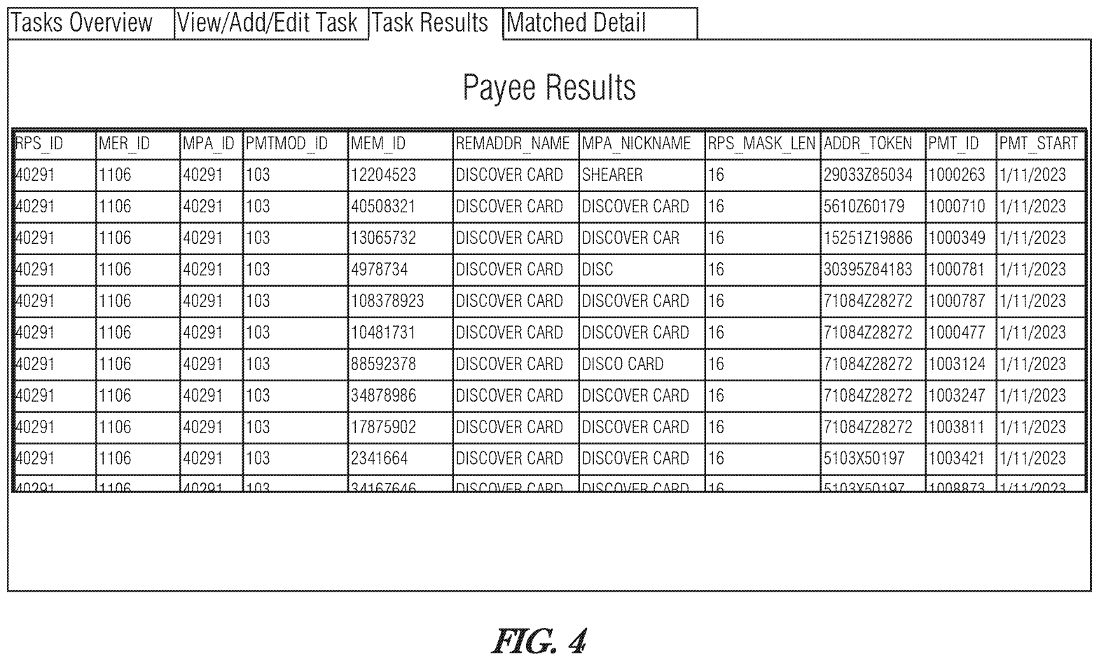

Returning to FIG. 2, the “Payee Import” task 206 is used to identify one or more payees that are in the pending transactions data store 202. A payee may be identified using information about the payee that is stored in the scheduled payment data structure or referred to in the scheduled payment data structure. For instance, pending payment transactions may include a reference to a payee or information about the payee, as entered or provided by a user/customer of the payee. The user information may be inaccurate or incomplete. For instance, the user may set the payee as “Big Bank” where the biller's full legal name is “Big Bank Credit and Deposit Company.” These user-provided names may be referred to as nicknames. The Payee Import task 206 returns the payees that are included in the pending transactions data store 202. FIG. 4 is a user interface of a payee report, according to an embodiment.

Turning to FIG. 4, the Payee Results screen provides a number of columns including, but not limited to RPS_ID, MER_ID, MPA_ID, PMTMOD_ID, MEM_ID, REMADDR_NAME, MPA_NICKNAME, RPS_MASK_LENGTH, ADDR_TOKEN, PMT_ID, and PMT_START. As with the Biller Results, RPS_ID is a unique identifier of a biller, which is a merchant at a specific remittance address, MER_ID is a unique identifier of a merchant, and PMTMOD_ID is an identifier of the payment processor. The MPA_ID is a unique identifier of the payee (biller plus customer account number). The MEM_ID is a unique identifier of the customer or user that set up the scheduled payment. The REMADDR_NAME is the standard name of the merchant for remittance. The MPA_NICKNAME is an optional nickname that the customer/user may assign to the payee. The RPS_MASK_LENGTH indicates the length of a merchant's account number. The ADDR_TOKEN is the token that is constructed from the remittance address.

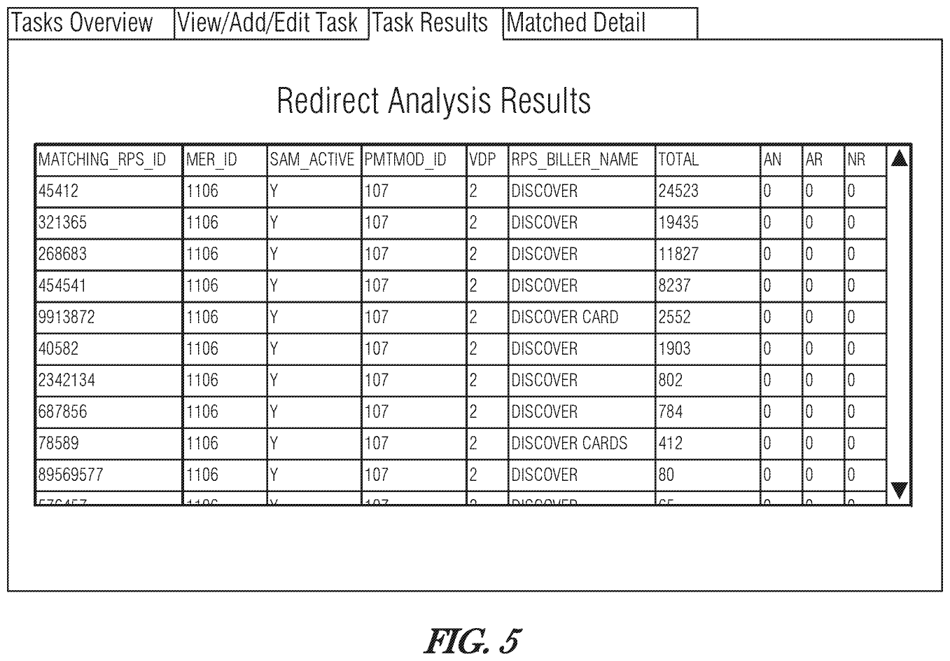

Returning to FIG. 2, the “Redirection Analysis” task 208 is used to determine billers that have electronic payment options available for payments that are scheduled in the pending transactions data store 202. To determine those billers that match payees, a matching process is used to match tokens that are constructed from merchant name and/or remittance address along with a match of a customer account number and a biller account mask. FIG. 5 is a user interface of a redirection analysis report, according to an embodiment.

A token is generated from a biller name and saved to RPS_NAME_TOKEN. This is compared to tokens generated for payee names, which are saved to NAME_TOKEN. Tokenization may be performed by scrubbing out non-essential parts of a string, in this case a merchant or payee name, and reducing the remaining characters to a hash. Non-essential parts of a name may include but are not limited to spaces, punctuation, and the like. This type of tokenization may be applied to other parts of a biller, merchant, or payee profile.

Scrubbing rules may be used to create the tokens. Rules are operations designed to compensate for potential inconsistencies, errors, or missing information that may result when a customer enters a desired payee's information into a customer request by identifying classes of merchant information and performing correction and gap-filling operations on those classes of merchant information. For example, in the context of merchant names, rules can include converting all letters into capital letters and eliminating all spaces and special characters (e.g., periods, commas, ampersands, hashes, and dashes). The rules can be further tailored to account for variance in the labeling of corporate entities, such as “Co.” and “Company” or “Corporation” and “Corp.” by identifying variants and permutations and converting them into their respective abbreviations. Applying these rules on a profiled merchant name “A-B, C, & D Credit Company” would yield “ABCDCREDITCO” as a merchant token. This token may be stored as a NAME_TOKEN in a token database. The ABCDCREDITCO token can then be associated with all variants and permutations of characters that could yield “ABCDCREDITCO” under this example set of merchant rules. In other words, regardless of whether a database has “A-B, C, & D Credit Co.” or “a, b, c, and d credit company” or “ABCD Credit Co.”, using the rules on these permutations will also yield “ABCDCREDITCO” for each of the entries. Accordingly, applying the rules to merchant information allows for accurate retrieval of the proper merchant token from the token database.

In some arrangements, different sets of rules are used to create different sets of tokens. For example, in the context of rules for processing merchant addresses, one set of address rules can be number-based, and eliminate all letters, spaces, and special characters, and then insert an asterisk (*) to separate each set of remaining numbers (e.g., “123 Broadway St., Ste. 4, City, State, 56789” becomes “123*4*56789”). Another set of address rules can be letter-based, and eliminate all numbers, spaces, special characters, and dashes, then capitalize each remaining letter, and finally convert all variants and permutations of address labels, such as street and unit terms into abbreviations (e.g., “123 Broadway Street, Suite 4, City, State, 56789” becomes “BROADWAYSTSTECITYSTATE”). Each of these alternatives can be used to create and store tokens in the token database.

The rules do not need to be divided into predetermined sets of rules. In some arrangements, the rules are maintained as a collection of independent token-generating rules that can, for example, be or serially run one after another, or subdivided into rule groups of rules in real time, and then applied.

To determine whether there is a match on the customer's account number, the length or format of the customer's account number is compared to a mask. The mask may be specific to a type of account, merchant, payment processing network, or the like. For instance, a mask for an AMERICAN EXPRESS® credit card is a string of fifteen numbers, whereas a mask for a VISA® credit card is a string of sixteen numbers. If the customer's account number indicates it is a VISA® account, but the account number formatting does not match the mask stored in the biller mask data structure 290, then the payment probably cannot be rerouted because it may raise errors.

Turning to FIG. 5, the Redirection Analysis Results screen provides a number of columns including, but not limited to MATCHING_RPS_ID, MER_ID, SAM_ACTIVE, PMTMOD_ID, VDP, RPS_BILLER_NAME, TOTAL, ANR, AN, AR, and NR. The MATCHING_RPS_ID is an identifier of a redirected biller, which is a merchant at a redirected remittance address. MER_ID is a unique identifier of a merchant. SAM_ACTIVE indicates whether a “scrub and match” matching process was used. The PMTMOD_ID is an identifier of the redirected (new) payment processor. The VDP is the time of the payment processing in the number of days. The RPS_BILLER_NAME is the primary biller name. Other aliases may be stored in the system.

The TOTAL, ANR, AN, AR, and NR columns indicate the number of scheduled payments in total, or that match a certain criteria where A is “Account,” N is “Name,” and R is “Remittance Address.” The matching process traverses each payee record contained in the selected payee dataset and finds the “best” matching biller in the selected biller dataset. A “match” is when two or more of the payee's key attributes match a biller's attribute. When all three attributes of a payee match a biller, an ANR is indicated. In such a case, the account number matches or is consistent with the biller mask, and the values for REMADDR_NAME and REMADDR_TOKEN match a biller's values. The status of “AN” indicates a partial match where the payee's account number matches or is consistent with the biller mask and one of its name attributes. The status of “AR” indicates a partial match where the payee's account number matches/passes the biller mask and its REMADDR_TOKEN token matches to a biller. An “NW” indicates a partial match on name and remittance address, but not on the account number mask. Records with “NR” are records that can be reviewed for further analysis, but likely they are not redirectable because there is not a confirmed matching account number.

In general, a set of redirection billers is calculated based on a match of payees with billers that support electronic payment modes, where the match is determined with a correspondence between the account number and the account mask and at least one of, a match between the payee name and the biller name (AN or ANR), or the payee remittance address and the biller remittance address (AR or ANR), of respective payees and billers. The output of redirection billers may be used by a human operator to reschedule non-electronic (e.g., paper) payments to electronic payments. The human operator may use one or more components of the financial institution computing system 106 to reschedule the payments. Optionally, the electronic payments for the set of redirection billers are automatically scheduled by the financial institution computing system 106.

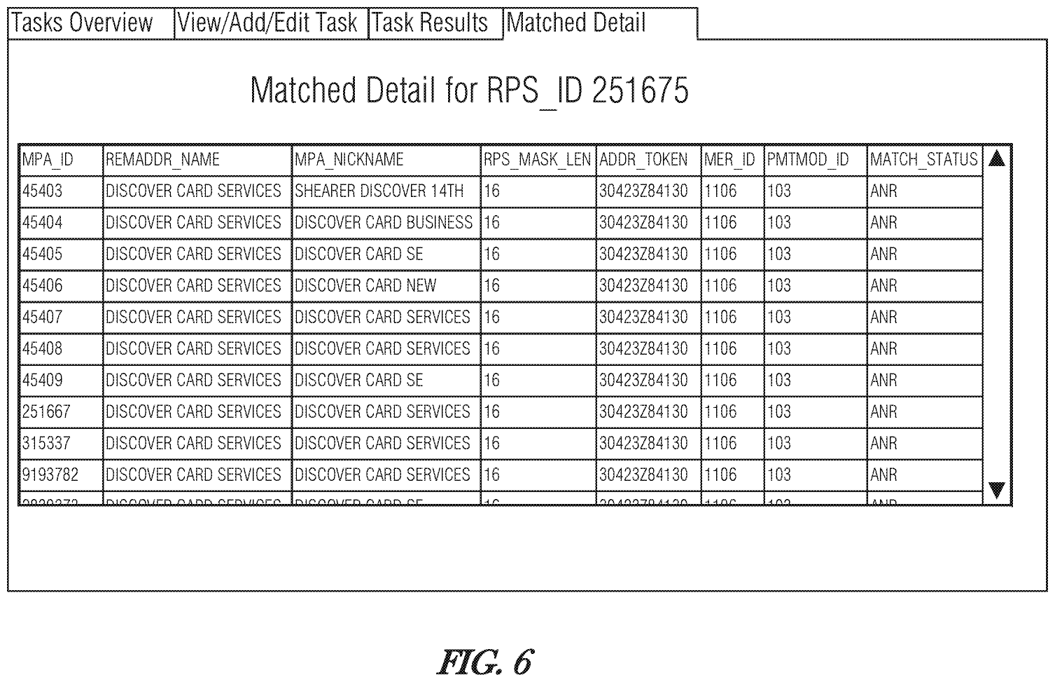

When viewing one row of redirected payments, one is able to drill down into details of the payments represented in the row. FIG. 6 is a Matched Detail screen for a specific biller, RPS_ID 251675. As shown in FIG. 6, each MPA_ID (payee identifier) is identified on its own row with details of the payment in additional columns.

The Biller Import task 204, Payee import task 206, or Redirection Analysis task 208 may use information from the historical payment data structure 280 or biller mask data structure 290 to determine valid results in the corresponding result sets.

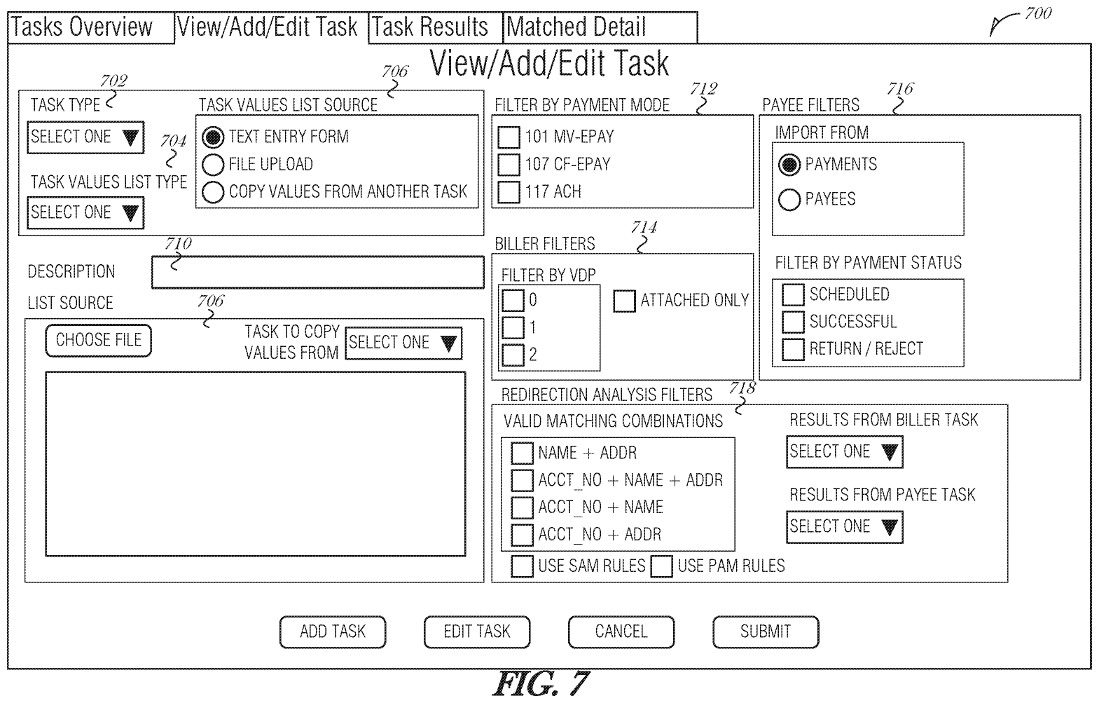

FIG. 7 is an example user interface 700 to create and edit tasks, according to an embodiment. A task type control 702 is used to select a task type to create or edit. The task types may include a “Biller Import” task, a “Payee Import” task, and a “Redirection Analysis” task. Input values for the task may be obtained from a list of express values, a file upload, a result list from another task, or the like. Input values are controlled and specified by the task values list type control 704, the task values list source control 706, and the list source control 708. A description control 710 is used to name the task.

Depending on the task type, various other controls may be enabled or disabled. The payment mode filters 712 may be used to selectively include different payment processors when creating or editing a Redirection Analysis task. The biller filters 714 may be used to selectively include payments due in the number of days (e.g., 0, 1, 2) for the Biller Import or the Payee Import tasks. The payee filters 716 may be used to filter payees for the Payee Import task. The redirection analysis filters 718 may be used to select the type of matching used and the input results sets for the Redirection Analysis task.

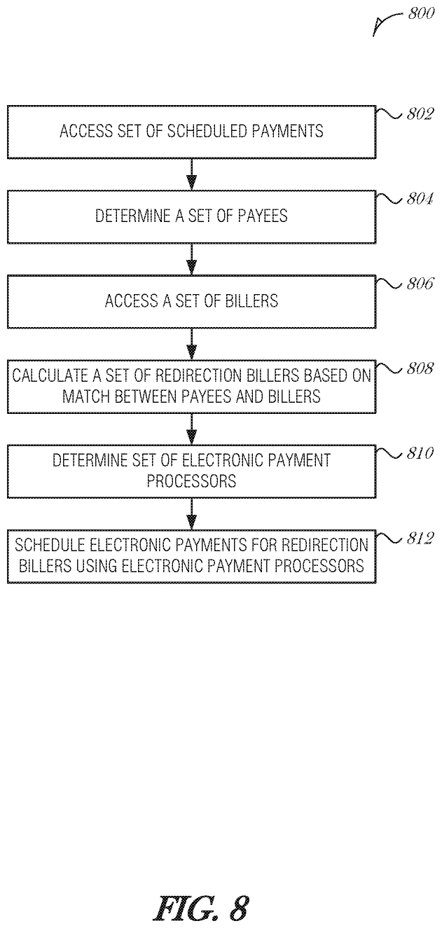

FIG. 8 is a flowchart illustrating a method 800 for rerouting electronic payments, according to an embodiment. The method 800 may be performed by an electronic online system (e.g., financial institution computing system 106) or any of the modules, logic, circuits, processors, or components described herein.

At 802, the method 800 includes the operations of accessing a set of scheduled payments, the set of scheduled payments to be made using a non-electronic payment mode.

At 804, the method 800 includes the operations of determining a set of payees from the set of scheduled payments, each of the payees having an account number, a payee name, and a payee remittance address.

At 806, the method 800 includes the operations of accessing a set of billers, each of the billers having an account mask, a biller name, and a biller remittance address.

At 808, the method 800 includes the operations of calculating a set of redirection billers based on a match of payees from the set of payees with billers from the set of billers, where billers in the set of redirection billers support electronic payment modes, and where the match is determined with a correspondence between the account number and the account mask and at least one of a match between the payee name and the biller name, or the payee remittance address and the biller remittance address, of respective payees and billers.

In an embodiment, there are a plurality of redirection billers in the set of redirection billers, and the method 800 includes the operations of displaying on an electronic display device, a total count of a number of payments corresponding to each of the plurality of redirection billers. In a further embodiment, the plurality of redirection billers are ordered in descending order of total count of the number of payments.

At 810, the method 800 includes the operations of determining a set of electronic payment processors corresponding to the set of redirection billers, where each electronic payment processor in the set of electronic payment processors is determined based at least on the biller name and the biller remittance address of the corresponding biller of the set of billers. In an embodiment, the set of electronic payment processors include a plurality of distinct payment processors.

At 812, the method 800 includes the operations of scheduling electronic payments for the set of redirection billers using the set of electronic payment processors.

In an embodiment, the payee name is tokenized to a payee name token, where the biller name is tokenized to a biller name token, and where the match between the payee name and the biller name is a match between the payee name token and the biller name token. In a further embodiment, the payee name and the biller name are tokenized by a tokenization rule. In various embodiments, the tokenization rule includes converting letters into capital letters and eliminating spaces and special characters, converting variant corporate labels to a standard corporate label, converting variant address labels to a standard address label, removing variant address labels, or removing letters, spaces, and special characters, and inserting an asterisk to separate remaining numbers.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

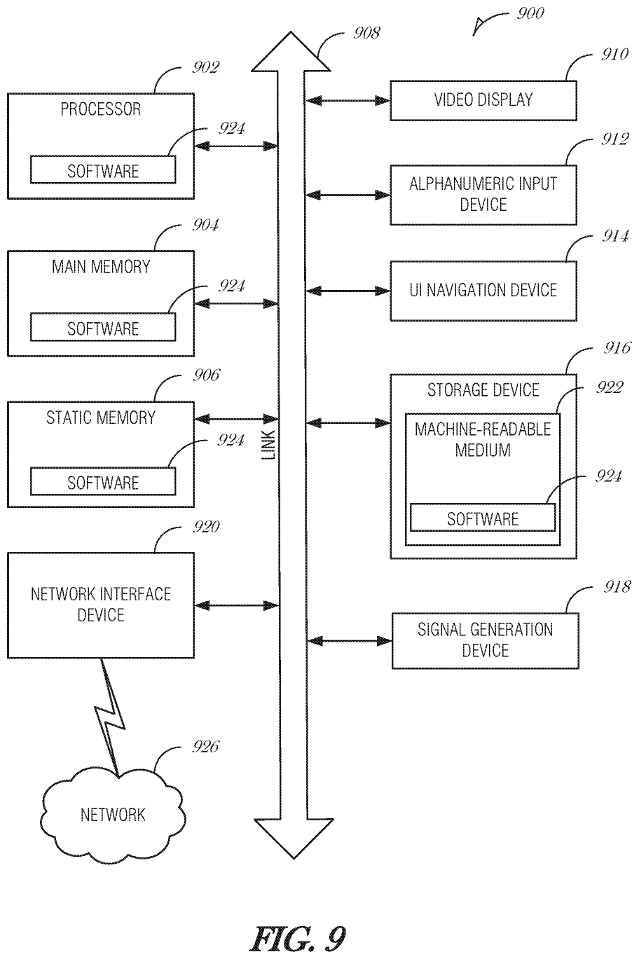

FIG. 9 is a block diagram illustrating a machine in the example form of a computer system 900, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, 4G LTE/LTE-A, 5G, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is an electronic online system comprising: a processor subsystem; and a memory including instructions, which when executed by the processor subsystem, cause the processor subsystem to: access a set of scheduled payments, the set of scheduled payments to be made using a non-electronic payment mode; determine a set of payees from the set of scheduled payments, each of the payees having an account number, a payee name, and a payee remittance address; access a set of billers, each of the billers having an account mask, a biller name, and a biller remittance address; calculate a set of redirection billers based on a match of payees from the set of payees with billers from the set of billers, wherein billers in the set of redirection billers support electronic payment modes, and wherein the match is determined with a correspondence between the account number and the account mask and at least one of: a match between the payee name and the biller name, or the payee remittance address and the biller remittance address, of respective payees and billers; determine a set of electronic payment processors corresponding to the set of redirection billers, wherein each electronic payment processor in the set of electronic payment processors is determined based at least on the biller name and the biller remittance address of the corresponding biller of the set of billers; and schedule electronic payments for the set of redirection billers using the set of electronic payment processors.

In Example 2, the subject matter of Example 1 includes, wherein the payee name is tokenized to a payee name token, and wherein the biller name is tokenized to a biller name token, and wherein the match between the payee name and the biller name is a match between the payee name token and the biller name token.

In Example 3, the subject matter of Examples 1-2 includes, wherein the payee name and the biller name are tokenized by a tokenization rule.

In Example 4, the subject matter of Example 3 includes, wherein the tokenization rule includes converting letters into capital letters and eliminating spaces and special characters.

In Example 5, the subject matter of Examples 3-4 includes, wherein the tokenization rule includes converting variant corporate labels to a standard corporate label.

In Example 6, the subject matter of Examples 3-5 includes, wherein the tokenization rule includes converting variant address labels to a standard address label.

In Example 7, the subject matter of Examples 3-6 includes, wherein the tokenization rule includes removing variant address labels.

In Example 8, the subject matter of Examples 3-7 includes, wherein the tokenization rule includes removing letters, spaces, and special characters, and inserting an asterisk to separate remaining numbers.

In Example 9, the subject matter of Examples 1-8 includes, wherein the set of electronic payment processors include a plurality of distinct payment processors.

In Example 10, the subject matter of Examples 1-9 includes, wherein there are a plurality of redirection billers in the set of redirection billers, and further comprising displaying on an electronic display device, a total count of a number of payments corresponding to each of the plurality of redirection billers.

In Example 11, the subject matter of Example 10 includes, wherein the plurality of redirection billers are ordered in descending order of total count of the number of payments.

Example 12 is a method performed on an electronic online system, the method comprising: accessing a set of scheduled payments, the set of scheduled payments to be made using a non-electronic payment mode; determining a set of payees from the set of scheduled payments, each of the payees having an account number, a payee name, and a payee remittance address; accessing a set of billers, each of the billers having an account mask, a biller name, and a biller remittance address; calculating a set of redirection billers based on a match of payees from the set of payees with billers from the set of billers, wherein billers in the set of redirection billers support electronic payment modes, and wherein the match is determined with a correspondence between the account number and the account mask and at least one of: a match between the payee name and the biller name, or the payee remittance address and the biller remittance address, of respective payees and billers; determining a set of electronic payment processors corresponding to the set of redirection billers, wherein each electronic payment processor in the set of electronic payment processors is determined based at least on the biller name and the biller remittance address of the corresponding biller of the set of billers; and scheduling electronic payments for the set of redirection billers using the set of electronic payment processors.

In Example 13, the subject matter of Example 12 includes, wherein the payee name is tokenized to a payee name token, and wherein the biller name is tokenized to a biller name token, and wherein the match between the payee name and the biller name is a match between the payee name token and the biller name token.

In Example 14, the subject matter of Examples 12-13 includes, wherein the payee name and the biller name are tokenized by a tokenization rule.

In Example 15, the subject matter of Example 14 includes, wherein the tokenization rule includes converting letters into capital letters and eliminating spaces and special characters.

In Example 16, the subject matter of Examples 14-15 includes, wherein the tokenization rule includes converting variant corporate labels to a standard corporate label.

In Example 17, the subject matter of Examples 14-16 includes, wherein the tokenization rule includes converting variant address labels to a standard address label.

In Example 18, the subject matter of Examples 14-17 includes, wherein the tokenization rule includes removing variant address labels.

In Example 19, the subject matter of Examples 14-18 includes, wherein the tokenization rule includes removing letters, spaces, and special characters, and inserting an asterisk to separate remaining numbers.

In Example 20, the subject matter of Examples 12-19 includes, wherein the set of electronic payment processors include a plurality of distinct payment processors.

In Example 21, the subject matter of Examples 12-20 includes, wherein there are a plurality of redirection billers in the set of redirection billers, and wherein the method further comprises displaying on an electronic display device, a total count of a number of payments corresponding to each of the plurality of redirection billers.

In Example 22, the subject matter of Example 21 includes, wherein the plurality of redirection billers are ordered in descending order of total count of the number of payments.

Example 23 is a non-transitory machine-readable medium comprising instructions, which when executed by a machine in an electronic online system, cause the machine to: access a set of scheduled payments, the set of scheduled payments to be made using a non-electronic payment mode; determine a set of payees from the set of scheduled payments, each of the payees having an account number, a payee name, and a payee remittance address; access a set of billers, each of the billers having an account mask, a biller name, and a biller remittance address; calculate a set of redirection billers based on a match of payees from the set of payees with billers from the set of billers, wherein billers in the set of redirection billers support electronic payment modes, and wherein the match is determined with a correspondence between the account number and the account mask and at least one of: a match between the payee name and the biller name, or the payee remittance address and the biller remittance address, of respective payees and billers; determine a set of electronic payment processors corresponding to the set of redirection billers, wherein each electronic payment processor in the set of electronic payment processors is determined based at least on the biller name and the biller remittance address of the corresponding biller of the set of billers; and schedule electronic payments for the set of redirection billers using the set of electronic payment processors.

In Example 24, the subject matter of Example 23 includes, wherein the payee name is tokenized to a payee name token, and wherein the biller name is tokenized to a biller name token, and wherein the match between the payee name and the biller name is a match between the payee name token and the biller name token.

In Example 25, the subject matter of Examples 23-24 includes, wherein the payee name and the biller name are tokenized by a tokenization rule.

In Example 26, the subject matter of Example 25 includes, wherein the tokenization rule includes converting letters into capital letters and eliminating spaces and special characters.

In Example 27, the subject matter of Examples 25-26 includes, wherein the tokenization rule includes converting variant corporate labels to a standard corporate label.

In Example 28, the subject matter of Examples 25-27 includes, wherein the tokenization rule includes converting variant address labels to a standard address label.

In Example 29, the subject matter of Examples 25-28 includes, wherein the tokenization rule includes removing variant address labels.

In Example 30, the subject matter of Examples 25-29 includes, wherein the tokenization rule includes removing letters, spaces, and special characters, and inserting an asterisk to separate remaining numbers.

In Example 31, the subject matter of Examples 23-30 includes, wherein the set of electronic payment processors include a plurality of distinct payment processors.

In Example 32, the subject matter of Examples 23-31 includes, wherein there are a plurality of redirection billers in the set of redirection billers, and the machine-readable medium include instructions for displaying on an electronic display device, a total count of a number of payments corresponding to each of the plurality of redirection billers.

In Example 33, the subject matter of Example 32 includes, wherein the plurality of redirection billers are ordered in descending order of total count of the number of payments.

Example 34 is at least one machine-readable medium including instructions that, when executed by processing circuitry, cause the processing circuitry to perform operations to implement of any of Examples 1-33.

Example 35 is an apparatus comprising means to implement of any of Examples 1-33.

Example 36 is a system to implement of any of Examples 1-33.

Example 37 is a method to implement of any of Examples 1-33.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An electronic online system comprising:
a processor subsystem; and
a memory including instructions, which when executed by the processor subsystem, cause the processor subsystem to:
access a set of scheduled payments, the set of scheduled payments to be made using a non-electronic payment mode;
determine a set of payees from the set of scheduled payments, each of the payees having an account number, a payee name, and a payee remittance address;
access a set of billers, each of the billers having an account mask, a biller name, and a biller remittance address;
calculate a set of redirection billers based on a match of payees from the set of payees with billers from the set of billers, wherein billers in the set of redirection billers support electronic payment modes, and wherein the match is determined with a correspondence between the account number and the account mask and at least one of: a match between the payee name and the biller name, or the payee remittance address and the biller remittance address, of respective payees and billers;
determine a set of electronic payment processors corresponding to the set of redirection billers, wherein each electronic payment processor in the set of electronic payment processors is determined based at least on the biller name and the biller remittance address of the corresponding biller of the set of billers; and
schedule electronic payments for the set of redirection billers using the set of electronic payment processors.

2. The system of claim 1, wherein the payee name is tokenized to a payee name token, and wherein the biller name is tokenized to a biller name token, and wherein the match between the payee name and the biller name is a match between the payee name token and the biller name token.

3. The system of claim 1, wherein the payee name and the biller name are tokenized by a tokenization rule.

4. The system of claim 3, wherein the tokenization rule includes converting letters into capital letters and eliminating spaces and special characters.

5. The system of claim 3, wherein the tokenization rule includes converting variant corporate labels to a standard corporate label.

6. The system of claim 3, wherein the tokenization rule includes converting variant address labels to a standard address label.

7. The system of claim 3, wherein the tokenization rule includes removing variant address labels.

8. The system of claim 3, wherein the tokenization rule includes removing letters, spaces, and special characters, and inserting an asterisk to separate remaining numbers.

9. The system of claim 1, wherein the set of electronic payment processors include a plurality of distinct payment processors.

10. The system of claim 1, wherein there are a plurality of redirection billers in the set of redirection billers, and further comprising displaying on an electronic display device, a total count of a number of payments corresponding to each of the plurality of redirection billers.

11. The system of claim 10, wherein the plurality of redirection billers are ordered in descending order of total count of the number of payments.

12. A method performed on an electronic online system, the method comprising:
accessing a set of scheduled payments, the set of scheduled payments to be made using a non-electronic payment mode;
determining a set of payees from the set of scheduled payments, each of the payees having an account number, a payee name, and a payee remittance address;
accessing a set of billers, each of the billers having an account mask, a biller name, and a biller remittance address;
calculating a set of redirection billers based on a match of payees from the set of payees with billers from the set of billers, wherein billers in the set of redirection billers support electronic payment modes, and wherein the match is determined with a correspondence between the account number and the account mask and at least one of: a match between the payee name and the biller name, or the payee remittance address and the biller remittance address, of respective payees and billers;
determining a set of electronic payment processors corresponding to the set of redirection billers, wherein each electronic payment processor in the set of electronic payment processors is determined based at least on the biller name and the biller remittance address of the corresponding biller of the set of billers; and
scheduling electronic payments for the set of redirection billers using the set of electronic payment processors.

13. The method of claim 12, wherein the payee name is tokenized to a payee name token, and wherein the biller name is tokenized to a biller name token, and wherein the match between the payee name and the biller name is a match between the payee name token and the biller name token.

14. The method of claim 12, wherein the payee name and the biller name are tokenized by a tokenization rule.

15. The method of claim 12, wherein the set of electronic payment processors include a plurality of distinct payment processors.

16. The method of claim 12, wherein there are a plurality of redirection billers in the set of redirection billers, and wherein the method further comprises displaying on an electronic display device, a total count of a number of payments corresponding to each of the plurality of redirection billers.

17. The method of claim 16, wherein the plurality of redirection billers are ordered in descending order of total count of the number of payments.

18. A non-transitory machine-readable medium comprising instructions, which when executed by a machine in an electronic online system, cause the machine to:
access a set of scheduled payments, the set of scheduled payments to be made using a non-electronic payment mode;
determine a set of payees from the set of scheduled payments, each of the payees having an account number, a payee name, and a payee remittance address;
access a set of billers, each of the billers having an account mask, a biller name, and a biller remittance address;
calculate a set of redirection billers based on a match of payees from the set of payees with billers from the set of billers, wherein billers in the set of redirection billers support electronic payment modes, and wherein the match is determined with a correspondence between the account number and the account mask and at least one of: a match between the payee name and the biller name, or the payee remittance address and the biller remittance address, of respective payees and billers;
determine a set of electronic payment processors corresponding to the set of redirection billers, wherein each electronic payment processor in the set of electronic payment processors is determined based at least on the biller name and the biller remittance address of the corresponding biller of the set of billers; and
schedule electronic payments for the set of redirection billers using the set of electronic payment processors.

19. The machine-readable medium of claim 18, wherein the payee name is tokenized to a payee name token, and wherein the biller name is tokenized to a biller name token, and wherein the match between the payee name and the biller name is a match between the payee name token and the biller name token.

20. The machine-readable medium of claim 18, wherein the payee name and the biller name are tokenized by a tokenization rule.
